(19) United States
(12) Patent Application Publication
(10) Pub. No.: US 2005/0070661 A1
(43) Pub. Date: Mar. 31, 2005

(54) Methods of preparing ophthalmic devices

(76) Inventor: Frank Molock, Orange Park, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/675,070

(22) Filed: Sep. 30, 2003

(51) Int. Cl. C08J 3/00; C08K 3/00; C08L 31/00; C08L 33/00

(52) U.S. Cl. 524/556

(57) ABSTRACT

The present invention relates to a method of making an ophthalmic device from uncured components comprising dissolving the uncured components in a diluent comprising α-methyl-ω-hydroxy poly(oxy-1,2-ethanediyl) and curing said uncured components.

### FIELD OF THE INVENTION

This invention relates to methods of preparing ophthalmic devices by dissolving components of said ophthalmic devices with a displaceable diluent.

### BACKGROUND OF THE INVENTION

Ophthalmic devices, such as contact lenses prepared from polymers, are often produced by direct molding of the devices into a mold. Typically a mixture of uncured monomers, and other components are blended together, loaded into a mold and subsequently cured. Using this process the topographical conformation of the mold produces the optical regions of the ophthalmic device.

One of the essential features of the process is that all of the components of the devices must be soluble so that a homogeneous mixture is loaded to the molds prior to curing. In addition, it is desirable that once the components are mixed that they remain in solution at, or close to, room temperature. This is particularly important in a manufacturing environment where the uncured mixtures often remain at room temperature prior to processing. However, often the uncured mixtures contain components having different solubility properties, such as hydrophilic monomers, hydrophobic monomers, cross linkers, polymerization catalysts and UV absorbers, so finding a method of dissolving all of those components can be difficult. This problem has been addressed in the past by the use of inert water or solvent displaceable diluents in processes to prepare ophthalmic articles. Displaceable diluents are substances that dissolve the components of ophthalmic lenses prior to curing, and after curing is completed, those diluents may be displaced by water or other solvents. Despite the success of these methods, they are not applicable for all ophthalmic devices having components of different solubility properties. This is particularly troublesome when UV absorbers are used. The UV absorbers used are organic compounds that are generally not soluble in solvents that dissolve hydrophilic monomers, particularly at concentrations of UV absorbers necessary to prevent corneal damage from UV radiation in both the UVA and UVB ranges. Therefore an unmet need remains for methods of preparing ophthalmic devices containing UV absorbers.

### SUMMARY OF THE INVENTION

The present invention relates to a method of making an ophthalmic device from uncured components comprising dissolving the uncured components in a diluent comprising a-methyl-w-hydroxy poly(oxy-1,2-ethanediyl) and curing said uncured components.

### DETAILED DESCRIPTION OF THE INVENTION

This invention includes a method of making a biomedical device comprising, consisting essentially of, or consisting of, dissolving the uncured components of said ophthalmic device in a diluent comprising α-methyl-ω-hydroxy poly(oxy-1,2-ethanediyl) and curing said uncured components.

As used herein, a “biomedical device” is any article that is designed to be used while either in or on mammalian tissues or fluid, and preferably in or on human tissue or fluids. Examples of these devices include but are not limited to catheters, implants, stents, and ophthalmic devices such as intraocular lenses and contact lenses. The preferred biomedical devices are ophthalmic devices, particularly contact lenses, most particularly contact lenses made from hydrogels.

As used herein, the terms “lens” and “ophthalmic device” refer to devices that reside in or on the eye. These devices can provide optical correction, wound care, drug delivery, diagnostic functionality, cosmetic enhancement or effect or a combination of these properties. The term lens includes but is not limited to soft contact lenses, hard contact lenses, intraocular lenses, overlay lenses, ocular inserts, and optical inserts.

As used herein the term “monomer”” is a compound containing at least one polymerizable group and an average molecular weight of about less than 2000 Daltons, as measure via gel permeation chromatography refractive index detection. The term “monomers”, may also be used to refer to oligomers made from more than one monomeric unit which are capable of further polymerization.

The “uncured components” may include, but are not limited to hydrophilic monomers, hydrophobic monomers, cross linkers, polymerization catalysts, UV absorbers, medicinal agents, dyes, combinations thereof and the like which are blended to form a reactive mixture and which upon curing becomes incorporated into the lens polymer.

As used herein α-methyl-ω-hydroxy poly(oxy-1,2-ethanediyl) refers to a polyether having the following base structure HO—[—CH₂—CH₂—O—]ₙ—CH₃ where n is between 4 to 20 more preferably between 6 to 10 (“α-methyl-ω-hydroxy poly(oxy-1,2-ethanediyl)”). The molecular weight of this polyether ranges from about 200 to about 5000, where a preferred range of about 300 to about 600 and a the preferred molecular weights of about 350 and about 500. In certain embodiments a molecular weight of about 300 is particularly preferred.

The diluents of the present invention comprise α-methyl-ω-hydroxy poly(oxy-1,2-ethanediyl). The diluents may comprise up to 20 weight %, preferably up to about 15 weight % and more preferably up to about 10 weight % of additional diluents which suitable for dissolving the selected uncured components. The weight percents are based upon the total amount of diluent used. Suitable additional diluents are disclosed in U.S. Pat. Nos. 5,498,379, 5,490,960, 5,490,959, 5,457,140 and EP 0642,039. All of the patents cited herein are hereby incorporated in their entireties by reference.

The percentage by weight of α-methyl-ω-hydroxy poly(oxy-1,2-ethanediyl) to the total weight of the uncured components ranges from about 20% to about 50%, preferably 25% to about 40%, more preferably about 30%.

It has been found that use of the α-methyl-ω-hydroxy poly(oxy-1,2-ethanediyl) as a diluent for non-ionic contact lens formulations reduces the Tg and the viscosity of the reactive monomer mix so that it may be stored and degassed at about room temperature (about 20° C.) and dosed into the lens assembly at room temperature. Thus, the α-methyl-ω-hydroxy poly(oxy-1,2-ethanediyl) provides a low viscosity formulation that is easily degassed and transferred in a contact lens production environment. Also the use of the α-methyl-ω-hydroxy poly(oxy-1,2-ethanediyl) as a diluent allow for reactive monomer mix to be cured for the prescribed time below the Tg, of the monomers in the monomer mix, which helps complete polymerization of all monomers used in the system. The resulting lenses may also be demolded at room temperature or elevated temperatures, which are common in lens manufacturing. The resulting lenses are pliable and resist chipping and cracking during demold.

Hydrophilic monomers are polymerizable compounds which are soluble in aqueous solutions. Suitable hydrophilic monomers comprising acrylic groups (CH₂═CROX, where R is hydrogen or C₁₋₆alkyl an X is O or N) or vinyl groups (—C═CH₂). Examples of hydrophilic monomers include but are not limited to glycerol monomethacrylate N,N-dimethylacrylamide, 2-hydroxyethyl methacrylate, 2-hydroxyethyl methacrylamide, polyethyleneglycol monomethacrylate, methacrylic acid, acrylic acid N-vinyl pyrrolidone, N-vinyl-N-methyl acetamide, N-vinyl-N-ethyl acetamide, N-vinyl-N-ethyl formamide, and N-vinyl formamide.

In addition to the monomers mentioned above, polyoxyethylene polyols having one or more of the terminal hydroxyl groups replaced with a functional group containing a polymerizable double bond are suitable hydrophilic monomers. Examples include but are not limited to polyethylene glycol, ethoxylated alkyl glucoside, and ethoxylated bisphenol A reacted with one or more molar equivalents of an end-capping group such as isocyanatoethyl methacrylate, methacrylic anhydride, methacryloyl chloride, vinylbenzoyl chloride, and the like, produce a polyethylene polyol having one or more terminal polymerizable olefinic groups bonded to the polyethylene polyol through linking moieties such as carbamate or ester groups.

Still further examples include the hydrophilic vinyl carbonate or vinyl carbamate monomers disclosed in U.S. Pat. Nos. 5,070,215, the hydrophilic oxazolone monomers disclosed in U.S. Pat. No. 4,910,277, and polydextran. The preferred hydrophilic monomers are 2-hydroxyethyl methacrylate and glycerol monomethacrylate.

Hydrophobic components are polymerizable compounds that are insoluble in aqueous solutions. Examples of suitable hydrophobic components include but are not limited to silicone macromers, prepolymers and monomers. Examples of silicone macromers include, without limitation, polydimethylsiloxane methacrylated with pendant hydrophilic groups as described in U.S. Pat. Nos. 4,259,467; 4,260,725 and 4,261,875; polydimethylsiloxane macromers with polymerizable function described in U.S. Pat. Nos. 4,136,250; 4,153,641; 4,189,546; 4,182,822; 4,343,927; 4,254,248; 4,355,147; 4,276,402; 4,327,203; 4,341,889; 4,486,577; 4,605,712; 4,543,398; 4,661,575; 4,703,097; 4,837,289; 4,954,586; 4,954,587; 5,346,946; 5,358,995; 5,387,632 ; 5,451,617; 5,486,579; 5,962,548; 5,981,615; 5,981,675; and 6,039,913; polysiloxane macromers incorporating hydrophilic monomers such as those described in U.S. Pat. Nos. 5,010,141; 5,057,578; 5,314,960; 5,371,147 and 5,336,797; macromers comprising polydimethylsiloxane blocks and polyether blocks such as those described in U.S. Pat. Nos. 4,871,785 and 5,034,461 combinations thereof and the like. All of the patents cited herein are hereby incorporated in their entireties by reference.

Suitable hydrophobic components also include oxyperm components such as is described in U.S. Pat. Nos. 5,760,100; 5,776,999; 5,789,461; 5,807,944; 5,965,631 and 5,958,440. Suitable siloxane monomers include tris(trimethylsiloxy)silylpropyl methacrylate, or the siloxane monomers described in U.S. Pat. Nos. 4,120,570, 4,139,692, 4,463,149, 4,450,264, 4,525,563; 5,998,498; 3,808,178; 4,139,513; 5,070,215; 5,710,302; 5,714,557 and 5,908,906.

“Cross-linkers” are compounds with two or more polymerizable functional groups. The crosslinker may be hydrophilic as in U.S. Pat. No. 5,64,350 or hydrophobic. Examples of suitable hydrophilic crosslinkers include compounds having two or more polymerizable functional groups, as well as hydrophilic functional groups such as polyether, amide or hydroxyl groups. Specific examples include TEGDMA (tetraethyleneglycol dimethacrylate), TrEGDMA (triethyleneglycol dimethacrylate), ethyleneglycol dimethacylate (EGDMA), ethylenediamine dimethyacrylamide, glycerol dimethacrylate, trimethylolpropane, trimethacrylate, glyceroltrimethacrylate, polyethylene glycol dimethacrylate (wherein the polyethylene glycol has a molecular weight up to e.g., about 5000, such as disclosed in U.S. Pat. No. 4,752,627) ethyleneglycol dimethacrylate and combinations thereof. The preferred cross linkers are tetraethylene glycol dimethacrylate, ethyleneglycol dimethacrylate, tetraethylene glycol dimethacrylate and mixtures thereof.

“Initiators” are compounds which generate free radical when exposed to heat or radiation. Suitable initiators include compounds such as lauryl peroxide, benzoyl peroxide, isopropyl percarbonate, azobisisobutyronitrile, and the like, and photoinitiator systems such as aromatic alpha-hydroxy ketones, alkoxyoxybenzoins, acetophenones, acyl phosphine oxides, and a tertiary amine plus a diketone, mixtures thereof and the like. Illustrative examples of photoinitiators are 1-hydroxycyclohexyl phenyl ketone (Irgacure 184), 2-hydroxy-2-methyl-1-phenyl-propan-1-one, thioxoanthen-9-one, bis(2,6-dimethoxybenzoyl)-2,4-4-trimethylpentyl phosphine oxide (DMBAPO), bis(2,4,6-trimethylbenzoyl)-phenylphosphineoxide (Irgacure 819), 2,4,6-trimethylbenzyldiphenyl phosphine oxide and 2,4,6-trimethylbenzyoyl diphenylphosphine oxide, benzoin methyl ester and a combination of camphorquinone and ethyl 4-(N,N-dimethylamino)benzoate. Commercially available visible light initiator systems include Irgacure 819, Irgacure 1700, Irgacure 1800, Irgacure 819, Irgacure 1850 (which is a 50%:50% blend of CAS # 145052-34-2 and CAS # 947-19-3) (all from Ciba Specialty Chemicals) and Lucirin TPO initiator (available from BASF). Commercially available UV photoinitiators include Darocur 1173 and Darocur 2959 (Ciba Specialty Chemicals). The initiator is used in the reaction mixture in effective amounts to initiate photopolymerization of the reaction mixture, e.g., from about 0.1 to about 2 parts by weight per 100 parts of reactive monomer. Polymerization of the reaction mixture can be initiated using the appropriate choice of heat or visible or ultraviolet light or other means depending on the polymerization initiator used. Alternatively, initiation can be conducted without a photoinitiator using, for example, e-beam. However, when a photoinitiator is used, the preferred initiator is a combination of 1-hydroxycyclohexyl phenyl ketone and bis(2,6-dimethoxybenzoyl)-2,4-4-trimethylpentyl phosphine oxide (DMBAPO), and the preferred method of polymerization initiation is visible light. The most preferred is bis(2,4,6-trimethylbenzoyl)-phenylphosphineoxide (Irgacure 819®). Any of the foregoing initiators may be used alone or in combination with other suitable photoinitiators.

“UV absorber” include substances that are added to ophthalmic devices to protect the cornea from damaging UV radiation. Examples of UV absorbers include but are not limited to 2-(2′-hydroxy-5-methacrylyloxyethylphenyl)-2H-benzotriazole and the UV blockers described in U.S. Pat. Nos. 6,218,463, 5,681,871, USRE 33,477, U.S. Pat. No. 4,304,895, and the benzotriazolyl hydrozyblenzophenones and others listed in U.S. Pat. No. 6,218,463.

As used herein “medicinal agents” refer to substances may be polymerized with ophthalmic devices once polymerized may be delivered to a wearer of the ophthalmic device through his or her eye. Examples of such medicinal agents include but are not limited to antiinlammatory, antibacterial, “dry eye” and glaucoma medicinal agents, combinations thereof and the like. Specific examples include salicylates, silver salts, silver zeolites, disinfecting organic dyes, phenoxy ethanol, benzalkonium chloride, cocophosphatidyl-dimonium chloride, iodine, chlorhexidene, bronopol, triclosan, antibiotic cationic peptides, triclosan, hexetidine, chlorhexidine salts, 2-bromo-2-nitropropane-1, 3-diol, hexyresorcinol, cetylpyridinium chloride, alkylbenzyldimethylammonium chlorides, phenol derivatives, povidone-iodine, parabens, hydantoins, hydantoin derivatives, ethylene diamine tetraacetic acid, cis isomer of 1-(3-chloroallyl)-3,5,6-triaza-1-axoniaadamantane chloride, diazolidinyl urea, benzethonium chloride, methylbenzethonium chloride, and mixtures thereof.

The term “dyes” refers to substances which impart color to the finished device. Suitable dyes include reactive or dispersed dyes, opacifying agents, visitants, color-enhancing dyes and combinations thereof. Suitable examples include those listed in U.S. Pat. Nos. 4,668,240; 5,352,245; 5,021,068; 5,938,795 and 5,292,350.

As noted above, the uncured components may contain additional components such as, but not limited to, hydrophilic monomers, hydrophobic monomers, cross linkers, polymerization catalysts, UV absorbers, medicinal agents, reactive tints, pigments, photochromic compounds, release agents and combinations thereof. It is preferred that the percentage of hydrophilic monomers in said uncured components is about 80% to about 98%, more preferably, about 90% to about 95%. When hydrophobic components are used, the percentage of hydrophobic monomers in said uncured components should be sufficient to provide up to 16 weight % Si and preferably up to 10 weight % Si in the final polymer, based upon all polymeric components. The percentage of cross linkers in said uncured components is about 0.99% to about 2.0%, preferably about 1.25% to about 1.6%. The percentage of UV blockers in said uncured components is about 1.0% to about 3.0%, preferably about 1.75% to about 2.4%. The percentage of polymerization catalysts is about 0.1% to about 1.0%, preferably about 0.5% to about 0.8%. Medicinal agents may be included in clinically effective amounts. As used herein, a “clinically effective amount” is an amount sufficient to yield a clinically desirable effect. For example, for an antimicrobial agent, a clinically effective amount would be the amount necessary to yield a reduction in bacterial colonization or population. Those of skill in the art will be able to determine the amount of medicinal agent necessary to achieve the desired result.

The term “curing” refers to the conditions, light, temperature or time that are required to polymerize the uncured components. Those conditions may vary depending upon the type of uncured components and are known to those who practice curing polymers.

Further, the invention includes an ophthalmic device made by a process comprising, consisting essentially of, or consisting of, dissolving the uncured components of said ophthalmic device in α-methyl-ω-hydroxy poly(oxy-1,2-ethanediyl) and curing said uncured components. The terms ophthalmic device, α-methyl-ω-hydroxy poly(oxy-1,2-ethanediyl), curing, and uncured components all have their aforementioned meanings and preferred ranges.

When the biomedical device is a contact lens the preferred method of production is placing the uncured formulation in a mold, curing and subsequently hydrating. Various processes are known for molding the reaction mixture in the production of contact lenses, including spincasting and static casting. Spincasting methods are disclosed in U.S. Pat. Nos. 3,408,429 and 3,660,545, and static casting methods are disclosed in U.S. Pat. Nos. 4,113,224 and 4,197,266 all of these patents are incorporated herein by reference.

A lens-forming amount of a lens material is dispensed into the mold. By “lens-forming amount” is meant an amount sufficient to produce a lens of the size and thickness desired. Typically, about 10 to about 40 mg of lens material is used.

The mold containing the lens material then is exposed to conditions suitable to form the lens. The precise conditions will depend upon the components of lens material selected and are within the skill of one of ordinary skill in the art to determine.

Preferably the reactive mixture is polymerized in an inert atmosphere which is substantially free of oxygen. Amounts of oxygen less than about 0.5% are preferable. Suitable inert gases include nitrogen and argon, with nitrogen being preferred.

The polymerization temperature is between about 20° C. and about 70° C., and preferably between about 40° C. and about 60° C. The polymerization is conducted for a time sufficient to fully cure the lens. Suitable times include those up to about 1 hour, preferably from about 1 minute to about 30 minutes and more preferably from about 1 minute to about 15 minutes. Suitable total radiation intensities include those up to about 8 mW/cm², and preferably include those between about 2 and 8 mW/cm². Those of skill in the art will appreciate that polymerization may take place in one or several zones, which may use the same or different conditions. In one embodiment cure is effected in at least two zones, a first zone having a low intensity (less than about 1 mW/cm² and a second zone having an intensity of greater than about 3 mW/cm². It will be appreciated by those of skill in the art that higher overall intensities require lower polymerization times.

The process of the present invention may also include a precure step. Suitable precure temperatures include temperatures between about 30° C. and about 60° C. and preferably about 35 and about 55° C.; light intensities of less than about 1 mW/cm² are suitable with intensities less than about 0.5 mW/cm² being preferred and precure times of less than about 5 minutes and preferably between about 30 seconds and about 3 minutes.

The equipment necessary to conduct polymerization is known in the art and includes lamp bulbs which emit radiation in the desired spectrum, such as (for visible wavelengths) those available from LCD Lighting Inc., including models F287T5/SDL/BP. The light intensity may moderated by using one or more wire screens (type 304 stainless steel; wire diameter 0.0075 inches) and/or changing the distance of the selected lamp from the molds.

Once curing is completed, the lens is released from the mold and may be treated with a solvent to remove the diluent and/or any traces of unreacted components. Lenses made according to the present invention may be demolded under relatively mild conditions, between about 20 and 50° C. The α-methyl-ω-hydroxy poly(oxy-1,2-ethanediyl) helps the lenses remain pliable and prevents chipping and cracking during demold without the use of excessive heating. The α-methyl-ω-hydroxy poly(oxy-1,2-ethanediyl) is also easily leached out of the lenses during the hydration process. The lens is then hydrated to form the hydrogel lens.

In order to illustrate the invention the following examples are included. These examples do not limit the invention. They are meant only to suggest a method of practicing the invention. Those knowledgeable in ophthalmic devices as well as other specialties may find other methods of practicing the invention. However, those methods are deemed to be within the scope of this invention.

The following tests were used in the examples.

Water content was measured using Leica Abbe Mark II Plus refractometer. A Leica 500 Arias refractometer or its equivalent could also be used. A lens equilibrated to room temperature is placed on a clean, calibrated prism in the prism assembly. The lamp is adjusted to provide maximum contrast and the dispersion correction control is adjusted to provide minimum color. The control knob is adjusted until the shadow line is in sharp focus and intersects with the cross hairs. The solids content is recorded. The water content is calculated by subtracting the solids content reading from 100%.

Elongation and modulus are measured by using the crosshead of a constant rate of movement type tensile testing machine equipped with a load cell that is lowered to the initial gauge height. A suitable testing machine includes an Instron model 1122. A dog-bone shaped sample having a 0.522 inch length, 0.276 inch “ear” width and 0.213 inch “neck” width is loaded into the grips and elongated at a constant rate of strain of 2 in/min. until it breaks.

The initial gauge length of the sample (Lo) and sample length at break (Lf) are measured. Twelve specimens of each composition are measured and the average is reported. Percent elongation is =[(Lf−Lo)/Lo]×100.

Tensile modulus is measured at the initial linear portion of the stress/strain curve.

### EXAMPLES

The following abbreviations are used in the examples below:
HEMA 2-hydroxyethyl methacrylate
Norbloc 2-(2′-hydroxy-5-methacrylyloxyethylphenyl)-2H-benzotriazole
Irgacure 1850 1:1 (wgt) blend of 1-hydroxycyclohexyl phenyl ketone and bis(2,6-dimethoxybenzoyl)-2,4-4-trimethylpentyl phosphine oxide
Blue HEMA the reaction product of Reactive Blue 4 and HEMA, as described in Example 4 of U.S. Pat. No. 5,944,853
TEGDMA tetraethyleneglycol dimethacrylate
GMMA glycerol mono methacrylate
Glucam E-20 poly(oxy-1,2-ethanediyl), .alpha.-hydro-.omega.-hydroxy-, ether with methyl D-glucopyranoside, also known as methyl gluceth-20, MW=1074 (ave.)
Glucam P-10 Poly[oxy(methyl-1,2-ethanediyl)], .alpha.-hydro-.omega.-hydroxy-, ether with methyl D-glucopyranoside, also known as methyl glucoside polyoxypropylene ether, MW=774 (ave.)
mPEG 350 α-methyl-ω-hydroxy poly(oxy-1,2-ethanediyl) average molecular weight of 350
DEG Diethylene Glygol
DPG Dipropylene Glycol
TEG Tetraethylene Glycol
TPG Tetrapropylene Glycol

### Example 1

Norbloc (3% by weight) was added to vials containing the solvents listed in Table 1. The vials were heated to 55-60° C. to dissolve the material and the apparent solubility of the solutions were noted. These solutions were allowed to cool to room temperature and left for 7 days. At the end of seven days the solubility of the solution were noted again.

TABLE 1

| Solvents | MW | Solubility at 55-60° C. | Solubility at 7 days |
|---|---|---|---|
| DEG | 106 | Soluble | Insoluble |
| DPG | 134 | Soluble | Insoluble |
| TEG | 194 | Insoluble | Insoluble |
| TPG | 250 | Soluble | Soluble |
| PEG 200 | 200 | Soluble | Insoluble |
| PEG 400 | 400 | Soluble | Insoluble |
| Glucam E-20 | 1066 | Soluble | Insoluble |
| Glucam P-10 | 766 | Soluble | Hazy |
| MPEG 350 | 350 | Soluble | Soluble |

This experiment demonstrates that a 3% Norbloc/mPEG 350 remains clear after seven days at room temperature.

### Example 2

The following components were mixed together under a nitrogen atmosphere HEMA (57.43%), Norbloc 7966 (2.25%) Irgacure 1850 (0.8%), TEDGMA (1.5%), GMMA (38.0%), and Blue HEMA (0.02%). The percentages are by weight based upon the total amount of these components. 70% of this mixture was diluted with 30% mPEG 350. The mixture was loaded to the front curve of lens molds. The back curves were place on the reaction mixture, which was cured from 1 minute to 8 minutes at 45 to 65° C. using a light source with an initial intensity of about 0.2 mW/cm² and an intensity of 8 mW/cm² for the last 2 minutes of the cure. The molds were opened and lenses were extracted into Dl water containing about 800 ppm Tween 80 and soaked at about _{—}60° C. for about 10 minutes to remove residual diluent and monomers. After solvent extration the lenses were placed into borate buffered saline for at least about 2 hours at a temperature of at least about 55° C. then and autoclaved at 122° C. for 30 minutes. Water content, modulus and elongation were 55.5% ±0.4%; 60.3±2.3 psi and 138.6% ±20.6%, respectively. As is shown by the examples MPEG 350, when used as a diluent, provides lenses have good properties.]

### Examples 3-12

The formulation used in Example 2, above was used, except that the amount of MPEG 350 and photoinitiator was varied as shown in Table 2, below. About 80 μl of monomer mix was placed between two parallel plates, spaced at 250 microns. One plate was transparent to light. The polymers were cured using light with an intensity of 4 mW/cm2 at a wavelength of 425 nm±25 nm. The monomer mixes were cured at 70° C., for about 25 minutes, with minimal rotational shear of about 1 Hz applied during the cure. The Tg was measured using a Haake Rheostress rheometer as follows. The curing lights were turned off and the temperature was decreased to 25° C. at a rate of 2° per minute with rotational shear of about 1 Hz. The shear modulus (G′) and loss modulus (G″) were measured at one minute intervals. The ratio of G″:G″ was plotted vs. temperature. The peak is Tg (cooling). At 25° C. the temperature was increased back to 70° C. at a rate of 2° C. per minute. G″ and G″0 were measured and plotted against temperature as above to yield Tg (heating). The results are shown in Table 2, below.

TABLE 2

| | % MPEG | % Irgacure | | |
|---|---|---|---|---|
| Ex. # | 350 | 1850 | Tg(° C.) heating | Tg(° C.) cooling |
| 3 | 20 | 0.8 | 74 | 80 |
| 4 | 25 | 0.8 | 64 | 77 |
| 5 | 30 | 0.8 | na | Na |
| 6 | 35 | 0.8 | 58 | 60 |
| 7 | 40 | 0.4 | 35 | 54 |
| 8 | 20 | 0.4 | 70 | 69 |
| 9 | 25 | 0.4 | 59 | 55 |
| 10 | 30 | 0.4 | 43 | 51 |
| 11 | 35 | 0.4 | 42 | 55 |
| 12 | 40 | 0.4 | 50 | 58 |

1. A method of making an ophthalmic device from uncured components comprising dissolving the uncured components in a diluent comprising α-methyl-ω-hydroxy poly(oxy-1,2-ethanediyl) and curing said uncured components.

2. The method of claim 1 wherein said diluent further comprises up to about 20 weight % of a second diluent.

3. The method of claim 1 wherein said diluent further comprises up to about 15 weight % of a second diluent.

4. The method of claim 1 wherein said diluent further comprises up to about 10 weight % of a second diluent.

5. The method of claim 1 wherein said uncured components comprise at least one hydrophilic monomer.

6. The method of claim 5 wherein said hydrophilic monomers are selected from the group consisting of glycerol monomethacrylate N,N-dimethylacrylamide, 2-hydroxyethyl methacrylate, glycerol methacrylate, 2-hydroxyethyl methacrylamide, polyethyleneglycol monomethacrylate, methacrylic acid, acrylic acid N-vinyl pyrrolidone, N-vinyl-N-methyl acetamide, N-vinyl-N-ethyl acetamide, N-vinyl-N-ethyl formamide, N-vinyl formamide and mixtures thereof.

7. The method of claim 5 wherein said hydrophilic monomers comprise polyoxyethylene polyols having one or more of the terminal hydroxyl groups replaced with a functional group containing a polymerizable double bond.

8. The method of claim 5 wherein said hydrophilic monomers are selected from the group consisting of polyethylene glycol, ethoxylated alkyl glucoside, and ethoxylated bisphenol A reacted with one or more molar equivalents of an end-capping group such as isocyanatoethyl methacrylate, methacrylic anhydride, methacryloyl chloride, vinylbenzoyl chloride.

9. The method of claim 5 wherein said hydrophilic monomers comprise from about 80 weight % to about 98 weight % of said uncured components.

10. The method of claim 5 wherein said hydrophilic monomers comprise from about 90 weight % to about 95 weight % of said uncured components.

11. The method of claim 5 wherein said uncured components further comprise at least on hydrophobic monomer.

12. The method of claim 5 wherein said uncured components further comprise at least additional component selected from the group consisting of crosslinkers, polymerization catalysts, UV absorbers, dyes, medicinal agents reactive tints, pigments, photochromic compounds, release agents and combinations thereof.

13. The method of claim 1 wherein said ophthalmic device is a contact lens.

14. The method of claim 1 said ophthalmic device is a soft contact lens.

15. The method of claim 14 wherein said soft contact lens is non-ionic.

16. A method of making an ophthalmic device from uncured components comprising dissolving the uncured components in a diluent comprising tetrapropyleneglycol and curing said uncured components.
